(19) United States
(12) Patent Application Publication
(10) Pub. No.: US 2024/0359573 A1
(43) Pub. Date: Oct. 31, 2024

(54) INTEGRATED CHARGING DEVICE FOR ELECTRIC VEHICLE

(71) Applicant: Changchun Jetty Automotive Technology Co., Ltd., Changchun, Jilin (CN)

(72) Inventors: Chao WANG, Jilin (CN); Zijian WANG, Jilin (CN)

(21) Appl. No.: 18/682,852

(22) PCT Filed: Aug. 12, 2022
(86) PCT No.: PCT/CN2022/112064

§ 371 Date: Feb. 9, 2024

(30) Foreign Application Priority Data
Aug. 13, 2021 (CN) 202110932833.1
Aug. 13, 2021 (CN) 202121898943.2

(51) Int. Cl. B60L 53/16; H01R 31/06; H02J 7/00

(52) U.S. Cl. CPC B60L 53/16; H02J 7/00032; H02J 7/0042; H01R 31/06

(57) ABSTRACT

An integrated charging device for an electric vehicle, including a high-power charging adapter, a charging gun head, a control box and a power supplying plug. The high-power charging adapter, the control box and the charging gun head are detachably and electrically connected in sequence to form a wall-mounted charging pile. The charging gun head, the control box and the power supplying plug are detachably and electrically connected in sequence to form a charging gun of mode 2. The present disclosure integrates the wall-mounted charging pile and the charging gun of mode 2, so that users can assemble the components of the charging device as required to obtain the wall-mounted charging pile or the charging gun of mode 2, thereby realizing free switching under different use conditions, which facilitates the use and saves the purchase cost.

### RELATED APPLICATION

The present disclosure claims priorities to Chinese Invention Patent Application No. 202110932833.1 filed on Aug. 13, 2021 and Chinese Utility Model Patent Application No. 202121898943.2 filed on Aug. 13, 2021, which are incorporated herein as a part of the present disclosure.

### TECHNICAL FIELD

The present disclosure relates to the technical field of charging of electric vehicles, and particularly to an integrated charging device for an electric vehicle.

### BACKGROUND

New energy automobiles have been increasingly popular, and owners use charging guns of mode 2 to charge their automobiles in emergencies. Mode 2 means that when an electric automobile is connected to an AC power source, a plug and a socket meeting the requirements of Chinese national standards GB2099.1 and GB1002 are used on a power source side; a phase line, a neutral line and a grounding protection conductor are used on the power source side; and an in-cable control is adopted during charging connection. When being at home, the owners usually uses charging piles with high charging power to charge the new energy automobiles. To this end, customers need to buy these two kinds of products to charge the new energy automobiles, in which the charging gun of mode 2 is portable and can be used as an emergency backup charging device, and the charging pile (e.g., wallbox charging pile) has the advantage of fast charging while being unportable. Generally, the owners will buy both of these two kinds of charging devices to meet different needs, but the purchase cost is high. Therefore, there is an urgent need for a new solution to solve the above problem in the prior art.

### SUMMARY

Embodiments of the present disclosure provide an integrated charging device for an electric vehicle, so as to solve the problem of high purchase costs for vehicle owners caused by separately purchasing a charging gun of mode 2 and a wall-mounted charging pile.

The embodiments of the present disclosure provide an integrated charging device for an electric vehicle, including a high-power charging adapter, a charging gun head, a control box and a power supplying plug. The high-power charging adapter, the control box and the charging gun head are detachably and electrically connected in sequence to form a wall-mounted charging pile. The charging gun head, the control box and the power supplying plug are detachably and electrically connected in sequence to form a charging gun of mode 2.

The characteristics and advantages of the integrated charging device for an electric vehicle of the embodiments of the present disclosure include:

1. The charging device of the present disclosure integrates the wall-mounted charging pile and the charging gun of mode 2, so that users can assemble the components of the charging device as required to obtain the wall-mounted charging pile or the charging gun of mode 2, thereby realizing free switching under different use conditions, which facilitates the use and saves the purchase cost.

2. The control box in the present disclosure can control the charging of both the charging pile and the charging gun, thereby improving the safety and reliability of the charging device.

### BRIEF DESCRIPTION OF DRAWINGS

The drawings, which are included to provide further understanding of the embodiments of the present disclosure and constitute a part of the specification, illustrate the embodiments of the present disclosure, and explain the principle of the present disclosure together with the description. Obviously, the drawings described below involve only some embodiments of this disclosure. For those of ordinary skill in the art, other drawings can be derived from these drawings without any inventive efforts. In the drawings:

FIG. 1 illustrates a schematic structural diagram of a high-power charging adapter according to an embodiment of the present disclosure;

FIG. 2 illustrates a schematic structural diagram of a charging gun head according to an embodiment of the present disclosure;

FIG. 3 illustrates a schematic structural diagram of a control box according to an embodiment of the present disclosure;

FIG. 4 illustrates a schematic structural diagram of a power supplying plug according to an embodiment of the present disclosure;

FIG. 5 illustrates a schematic structural diagram of a wall-mounted charging pile according to an embodiment of the present disclosure; and

FIG. 6 illustrates a schematic structural diagram of a charging gun of mode 2 according to an embodiment of the present disclosure.

### DETAILED DESCRIPTION OF EMBODIMENTS

For a clearer understanding of the objectives, technical features and effects of the embodiments of the present disclosure, specific embodiments will now be described with reference to the drawings. The described embodiments are intended only to schematically illustrate and explain this invention and do not limit the scope of the present disclosure.

In the description of the present disclosure, unless otherwise specified, the term ‘connection’ should be should be interpreted in a broad sense, such as a fixed connection, a detachable connection, a direct connection, or an indirect connection through an intermediate medium, and those skilled in the art can understand the specific meanings of the above terms in this patent according to specific circumstances. The ‘high power’ mentioned herein refers to a power greater than 1 kw, and the commonly used high power are 3.6 kw, 7.2 kw, 11 kw, 22 kw, etc.

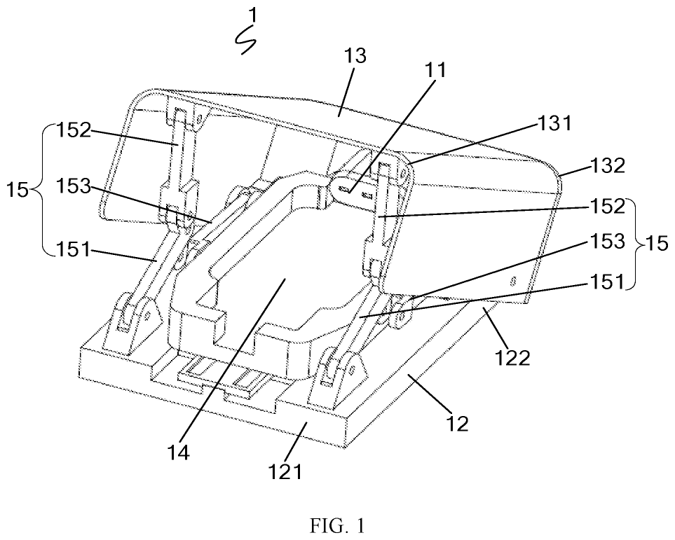

As illustrated in FIGS. 1 to 6, embodiments of the present disclosure provide an integrated charging device for an electric vehicle, including a high-power charging adapter 1, a charging gun head 2, a control box 3 (i.e. an in-cable control and protection device) and a power supplying plug 4. The high-power charging adapter 1, the control box 3 and the charging gun head 2 are detachably and electrically connected in sequence to form a wall-mounted charging pile 100. The charging gun head 2, the control box 3 and the power supplying plug 4 are detachably and electrically connected in sequence to form a charging gun of mode 2.

The charging device of the present disclosure integrates the wall-mounted charging pile and the charging gun of mode 2, so that users can assemble the components of the charging device as required to obtain the wall-mounted charging pile or the charging gun of mode 2, thereby realizing free switching under different use conditions, which facilitates the use and saves the purchase cost.

In some embodiments, the control box 3 includes a first control module configured to control the charging of the wall-mounted charging pile 100 and a second control module configured to control the charging of the charging gun 200 of mode 2.

In this embodiment, the principle of a control pilot circuit of the first control module is illustrated in a schematic diagram of a control pilot circuit of a charging mode 3 or charging mode 4 in the PRC national standard GB/T18487.1, and the principle of a control pilot circuit of the second control module is illustrated in a schematic diagram of a control pilot circuit of a charging mode 2 in the PRC national standard GB/T18487.1.

In a first embodiment, activations of the first control module and the second control module are controlled by a manual switch or an automatic switch, i.e., the control box further includes a first switch through which the first control module is turned on (activated) or off, and a second switch through which the second control module is turned on (activated) or off.

In this embodiment, when the charging device is to be used as the wall-mounted charging pile 100, the first switch is turned on and the second switch is turned off to activate the first control module and deactivate the second control module. When the charging device is to be used as the charging gun 200 of mode 2, the second switch is turned on and the first switch is turned off to activate the second control module and deactivate the first control module.

In a second embodiment, activations of the first control module and the second control module are automatically controlled by a switching device in the control box, i.e., the control box further includes a switching device, which is electrically connected to the first control module and the second control module respectively. The switching device is configured to identify power parameters such as current, voltage and frequency, and activate the first control module or the second control module according to the identified power parameters, thereby realizing automatic control and switching.

Specifically, the switching device is a circuit board storing control program codes. The circuit board is configured to identify parameters of a power grid end through the hardware of the circuit board, and invoke corresponding control program codes according to the parameters, thereby realizing logic switching.

Further, the switching device includes an identification module configured to identify power parameters of the power grid end, and a switching module configured to control the first control module or the second control module to be electrically connected to the power grid end according to the power parameters identified by the identification module.

In this embodiment, the control box 3 automatically identifies the power parameters such as rated voltage, current and frequency at the power grid end, and invokes the first control module or the second control module according to an identification result.

For example, when the control box 3 is connected to the high-power charging adapter 1 and the charging gun head 2, the identification module of the control box 3 identifies the power parameters (called first power parameters) such as voltage, current and frequency of a corresponding power grid end (called a first power grid end), and the switching module invokes the first control module according to the first power parameters to enable the first control module to be conducted with the first power grid end, so as to control the charging of the wall-mounted charging pile 100 through the first control module. When the control box 3 is connected to the power supplying plug 4 and the charging gun head 2, the identification module of the control box 3 identifies the power parameters (called second power parameters) such as voltage, current and frequency of a corresponding power grid end (called a second power grid end), and the switching module invokes the second control module according to the second power parameters to enable the second control module to be conducted with the first power grid end, so as to control the charging of the mode two charging gun 200 through the 5 second control module.

The above power parameters such as voltage, current and frequency may be set as required with reference to the PRC national standard GB/T 156, the European standard IEC60038 and its subsidiary standards, or the standards of other countries, and the specific values are not limited herein.

Therefore, the control box 3 in the embodiments can control the charging of both the wall-mounted charging pile 100 and the charging gun 200 of mode 2, and can automatically invoke the corresponding control module by identifying the power parameters such as rated voltage, current and frequency at the power grid end, which is safe and convenient to use.

As illustrated in FIGS. 1 to 6, in some embodiments, the high-power charging adapter 1 includes a first male end 11, the control box 3 includes a utility female end 31 and a gun connecting female end 32, the charging gun head 2 includes a second male end 21, and the power supplying plug 4 includes a third male end 41. The control box 3 is plugged with the second male end 21 through the gun connecting female end 32, and plugged with the first male end 11 or the third male end 41 through the utility female end 31.

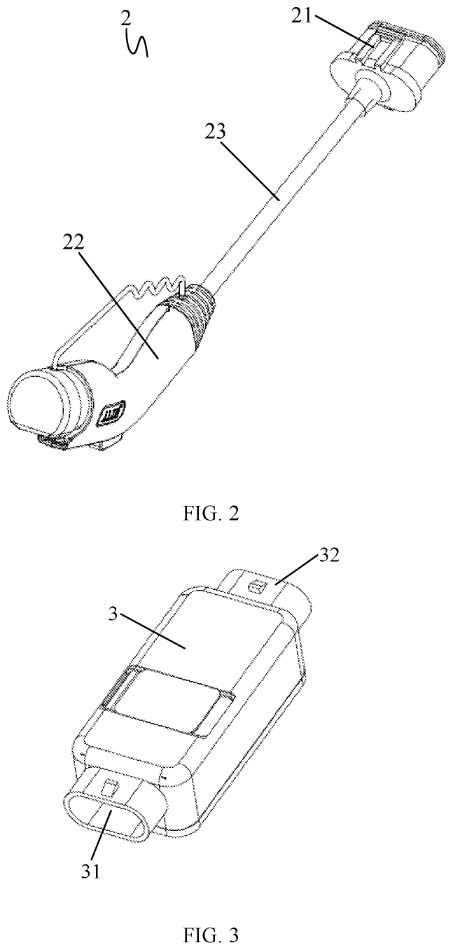

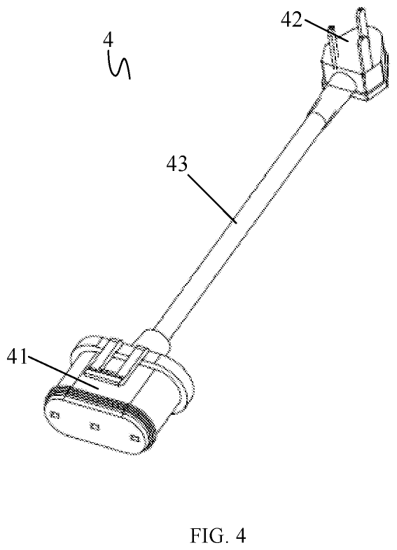

As illustrated in FIGS. 2 and 4, further, the charging gun head 2 includes a gun head body 22 and a first cable 23, and the gun head body 22, the first cable 23 and the second male end 21 are fixedly connected in sequence. The gun head body 22 can be plugged into an electric vehicle. The power supplying plug 4 includes a power source plug 42 and a second cable 43, and the power source plug 42, the second cable 43 and the third male end 41 are fixedly connected in sequence. The power source plug 42 can be plugged into a power supplying socket.

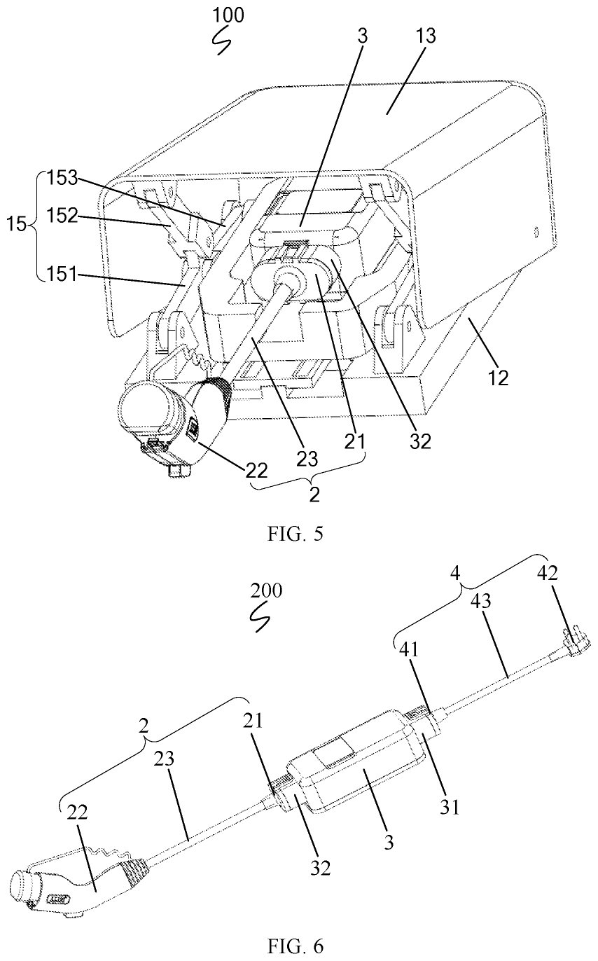

As illustrated in FIG. 5, when there is a need to use a wall-mounted charging pile 100 for charging, the gun connecting female end 32 of the control box 3 is plugged with the second male end 21 of the charging gun head 2, and the utility female end 31 of the control box 3 is plugged with the first male end 11 of the high-power charging adapter 1, to obtain the wall-mounted charging pile 100. Next, the gun head body 22 of the charging gun head 2 is plugged with an electric vehicle to perform charging.

As illustrated in FIG. 6, when there is a need to use a charging gun 200 of mode 2 for charging, the gun connecting female end 32 of the control box 3 is plugged with the second male end 21 of the charging gun head 2, and the utility female end 31 of the control box 3 is plugged with the third male end 41 of the charging gun 200 of mode 2, to obtain the charging gun 200 of mode 2. Next, the gun head body 22 of the charging gun head 2 is plugged with an electric vehicle, and the power source plug 42 of the power supplying plug 4 is plugged with a power supplying socket, to perform charging.

As illustrated in FIG. 5, in some embodiments, the high-power charging adapter 1 includes a connector body 12 and an upper cover 13. The connector body 12 is provided with an accommodating groove 14 for accommodating the control box 3, and the first male end 11 is fixed on the connector body 12 and adjacent to the accommodating groove 14. When the utility female end 31 of the control box 3 is plugged with the first male end 11, the control box 3 is located just in the accommodating groove 14, and the upper cover 13 is capable of shielding the accommodating groove 14 by covering over the connector body 12.

As illustrated in FIGS. 1 and 5, further, the connector body 12 and the upper cover 13 are rotatably connected to each other, so that the connector body 12 and the upper cover 13 can be relatively opened or closed by relative rotation, which is convenient to operate.

As illustrated in FIGS. 1 and 5, further, the connector body 12 includes a first front end 121 and a first rear end 122, the upper cover 13 includes a second front end 131 and a second rear end 132, the second rear end 132 of the upper cover 13 is rotatably connected to the first rear end 122 of the connector body 12, and the second front end 131 of the upper cover 13 is rotatably connected to the first front end 121 of the connector body 12 through a power-assisting hinge. By rotating the power-assisting hinge, the second front end 131 of the upper cover 13 and the first front end 121 of the connector body 12 are moved towards or away from each other, so that the connector body 12 and the upper cover 13 are relatively opened or closed. When the utility female end 31 of the control box 3 is plugged with the first male end 11 by a plugging force, the plugging force is transmitted to the power-assisting hinge via the connector body 12 to drive the power-assisting hinge to be rotated and cause the connector body 12 to be moved towards the upper cover 13, so that the connector body 12 and the upper cover 13 are relatively closed. Therefore, by disposing the power-assisting hinge in this solution, the operation of plugging the control box 3 to the first male end 11 of the connector body 12 also simultaneously causes the connector body 12 and the upper cover 13 to be relatively closed, which is convenient to operate, thereby providing great convince to users.

As illustrated in FIGS. 1 and 5, specifically, for example, the power-assisting hinge includes two groups of hinge structures 15, which are located at two opposite sides of the receiving groove 14, respectively. Each group of hinge structure 15 includes a first rotating rod 151 and a second rotating rod 152, one end of the first rotating rod 151 is rotatably connected to the first front end 121 of the connector body 12, one end of the second rotating rod 152 is rotatably connected to the second front end 131 of the upper cover 13, and the other end of the first rotating rod 151 is rotatably connected to the other end of the second rotating rod 152.

Further, each group of hinge structure 15 further includes a connecting rod 153, which has one end rotatably connected to the first rear end 122 of the connector body 12, and the other end rotatably connected to the other end of the first rotating rod 151, so that a swing amplitude of the first rotating rod 151 is limited by the connecting rod 153.

Although the specific embodiments of the present disclosure have been described above, those skilled in the art should appreciate that such embodiments are only examples, and the protection scope of the present disclosure is defined by the appended claims. Those skilled in the art can make many variations or modifications to these embodiments without departing from the principle or essence of the present disclosure, and these variations or modifications should fall within the protection scope of the present disclosure.

1. An integrated charging device for an electric vehicle, comprising a high-power charging adapter, a charging gun head, a control box and a power supplying plug;
wherein the high-power charging adapter, the control box and the charging gun head are detachably and electrically connected in sequence to form a wall-mounted charging pile; and
the charging gun head, the control box and the power supplying plug are detachably and electrically connected in sequence to form a charging gun of mode 2.

2. The integrated charging device for an electric vehicle according to claim 1, wherein the high-power charging adapter comprises a first male end, the control box comprises a utility female end and a gun connecting female end, the charging gun head comprises a second male end, and the power supplying plug comprises a third male end; and
the control box is plugged with the second male end through the gun connecting female end, and the control box is plugged with the first male end or the third male end through the utility female end.

3. The integrated charging device for an electric vehicle according to claim 2, wherein the charging gun head comprises a gun head body and a first cable;
the gun head body, the first cable and the second male end are fixedly connected in sequence;
the power supplying plug comprises a power source plug and a second cable; and
the power source plug, the second cable and the third male end are fixedly connected in sequence.

4. The integrated charging device for an electric vehicle according to claim 2, wherein the high-power charging adapter comprises a connector body and an upper cover, the connector body is provided with an accommodating groove for accommodating the control box, the first male end is fixed on the connector body and adjacent to the accommodating groove, and the upper cover is capable of shielding the accommodating groove by covering over the connector body.

5. The integrated charging device for an electric vehicle according to claim 4, wherein the connector body and the upper cover are rotatably connected to each other, so as to be relatively opened or closed by relative rotation.

6. The integrated charging device for an electric vehicle according to claim 5, wherein the connector body comprises a first front end and a first rear end, the upper cover comprises a second front end and a second rear end, the second rear end of the upper cover is rotatably connected to the first rear end of the connector body, the second front end of the upper cover is rotatably connected to the first front end of the connector body through a power-assisting hinge, and the second front end of the upper cover and the first front end of the connector body are moved towards or away from each other by rotation of the power-assisting hinge; and
a plugging force for plugging the utility female end of the control box to the first male end is transmitted to the power-assisting hinge via the connector body, to drive the power-assisting hinge to be rotated and cause the connector body to be moved towards the upper cover.

7. The integrated charging device for an electric vehicle according to claim 6, wherein the power-assisting hinge comprises two groups of hinge structures, which are located at two opposite sides of the receiving groove, respectively; and
each group of hinge structure comprises a first rotating rod and a second rotating rod, one end of the first rotating rod is rotatably connected to the connector body, one end of the second rotating rod is rotatably connected to the upper cover, and the other end of the first rotating rod is rotatably connected to the other end of the second rotating rod.

8. The integrated charging device for an electric vehicle according to claim 1, wherein the control box comprises control modules configured to control the charging of the wall-mounted charging pile and the charging of the charging gun of mode 2.

9. The integrated charging device for an electric vehicle according to claim 8, wherein the control modules include a first control module configured to control the charging of the wall-mounted charging pile and a second control module configured to control the charging of the charging gun of mode 2.

10. The integrated charging device for an electric vehicle according to claim 9, wherein the control box further comprises a switching device, which is electrically connected to the first control module and the second control module respectively; and
the switching device is configured to identify power parameters, and activate the first control module or the second control module according to the identified power parameters.

11. The integrated charging device for an electric vehicle according to claim 10, wherein the switching device comprises:
an identification module configured to identify the power parameters of a power grid end; and
a switching module configured to control the first control module or the second control module to be electrically connected to the power grid end according to the power parameters identified by the identification module.

12. The integrated charging device for an electric vehicle according to claim 9, wherein the control box further comprises a first switch and a second switch, the first control module is turned on or off by the first switch, and the second control module is turned on or off by the second switch.

13. The integrated charging device for an electric vehicle according to claim 12, wherein the first switch is a manual switch, and the second switch is a manual switch.

14. The integrated charging device for an electric vehicle according to claim 10, wherein the switching device is a circuit board.

15. The integrated charging device for an electric vehicle according to claim 1, wherein the control box include a first control module configured to control the charging of the wall-mounted charging pile and a second control module configured to control the charging of the charging gun of mode 2.
